(19) United States
(12) Patent Application Publication
(10) Pub. No.: US 2021/0176620 A1
(43) Pub. Date: Jun. 10, 2021

(54) METHODS, SUBSCRIBER IDENTITY COMPONENT AND MANAGING NODE FOR PROVIDING WIRELESS DEVICE WITH CONNECTIVITY

(71) Applicant: Tele2 Sverige AB, Kista (SE)

(72) Inventors: Jonas Hallman, Sollentuna (SE); Daniel Martin, Sollentuna (SE); Ulrik Grundberg, Enskededalen (SE); Pontus Winblad, Nacka (SE)

(73) Assignee: Tele2 Sverige AB, Kista (SE)

(21) Appl. No.: 16/768,641

(22) PCT Filed: Nov. 29, 2018
(86) PCT No.: PCT/EP2018/083019

§ 371 Date: May 29, 2020

(30) Foreign Application Priority Data
Dec. 1, 2017 (SE) 1751485-2

(51) Int. Cl. H04W 8/06; H04L 29/12; H04W 12/30; H04W 12/40; H04W 4/02; H04W 12/63; H04W 12/02; H04W 60/00

(52) U.S. Cl. CPC H04W 8/065; H04L 61/6054; H04W 12/35; H04W 60/00; H04W 4/025; H04W 12/63; H04W 12/02; H04W 12/40

(57) ABSTRACT

A method and a subscriber identity component for providing a wireless device with connectivity as well as a managing node for managing a request for registration are disclosed. The subscriber identity component performs a set of actions, including providing a primary subscriber identity. The set of actions includes monitoring information related to ciphering of communication to the network. Additionally, the set of action includes monitoring information related to registration of a location of the wireless device. The managing node receives, from the wireless device, the request for registration. When an indication of availability is set to unavailable, the managing node refrains from forwarding the request, and transmits a response indicating that registration is denied.

### TECHNICAL FIELD

Embodiments herein relate to connectivity management for subscriber identity components, such as SIMs, UICCs, eUICCs and the like, for use in wireless communication systems, such as cellular networks and the like. In particular, a method and a subscriber identity component for providing a wireless device with access to a network node as well as a managing node for managing a request for registration are disclosed. Corresponding computer programs and computer program carriers are also disclosed.

### BACKGROUND

A mobile device, operable in wireless systems like telecommunication system, is equipped with a unique subscriber identity, often referred to as an International Mobile Subscriber Identity (IMSI). The unique subscriber identity, as well as other credentials, is used when the mobile device gains access, or attaches, to a network, such as a cellular network, a telecommunication network, or the like. The unique subscriber identity is typically stored in a Universal Integrated Circuit Card (UICC), which can be inserted into the mobile device.

The UICC is personalised, i.e. assigned a particular IMSI, before it is inserted into the mobile device. This kind of personalisation can be performed by a manufacturer of the UICC, often a long time before a wireless device is provided with the UICC and subsequently powered on in the network. The IMSI determines, among other things, the local network to be to which the IMSI belongs, as well as to which roaming networks, in addition to the local network, the UICC is allowed to attach. Roaming agreements between operators for the stored IMSI ensures that the IMSI can attach to additional networks other than the local network of the IMSI. When the UICC with the assigned IMSI is inserted into a device, it is thus already decided in which region it can be operated. The particular IMSI needs to be activated in e.g. a Home Location Register (HLR), i.e. a back-end network operator system, in order for the device to gain access to the network(s).

In order to solve various issues related to personalizing of Subscriber Identity Modules (SIMs), US20110136482 proposes a method for commissioning and personalizing a subscriber identification module (SIM). The SIM is initially set up, prior to a first commissioning, with a preliminary subscriber identification (IMSI*), included in a preliminary non-individual data set (S*). The preliminary non-individual data set (S*) allows the first commissioning of the SIM in a mobile telecommunications network to be successful. Personalizing is then performed after the first commissioning of the SIM, in that an individual and final subscriber data set (S) is transferred to and stored on the SIM, particularly comprising a unique final subscriber identification (IMSI) and a unique final secret key (K), particularly in that the final subscriber data set (S) is transferred by means of a regular connection of the mobile telecommunications system using the preliminary set (S*).

With aforementioned US20110136482, it may happen that two devices with the same IMSI may attempt to access the network simultaneously or almost simultaneously. It is proposed to put devices, using the same IMSI and performing simultaneous or almost simultaneous accesses to the network, in a queue. Disadvantageously, one of the devices will have to wait before it can attempt to access the network again. The queue disadvantageously grows as number of multiple simultaneous, or at least partially overlapping, accesses with the same IMSI occur. This means that time to wait before a new attempt can be made increases with length of the queue. For example, when a first device attempts to access the network and the IMSI is in use, the first device will be put in queue. Then, when a second device attempts to access the network with the same IMSI, the second device will be put last in the queue.

### SUMMARY

An object may be to overcome, or at least alleviate, the above mentioned disadvantage relating to network access, or connectivity, using subscriber identity components, such as the above mentioned UICC, embedded UICC, SIM or the like. In particular, an object may be to reduce, or eliminate, waiting time due to collisions between different devices using the same subscriber identity.

According to an aspect, the object is achieved by a method, performed by a subscriber identity component, for providing a wireless device with connectivity to a network. The subscriber identity component performs a set of actions. The set of actions comprises that the subscriber identity component provides a primary subscriber identity out of at least two obtainable subscriber identities, whereby the wireless device seeks connectivity in the network by use of the primary subscriber identity. Furthermore, the set of actions comprises that the subscriber identity component monitors information related to ciphering of communication to the network. Moreover, the set of actions comprises that the subscriber identity component monitors information related to registration of a location of the wireless device with the network, when the information related to ciphering indicates that a ciphering key has been obtained. The set of actions are performed again when the information related to registration indicates that the wireless device is denied to register the location in the network.

According to another aspect, the object is achieved by a method, performed by a managing node, for managing a request for registration with a registration node for registration of a location related to a wireless device. A core network of a telecommunication network comprises the managing node and the registration node. The managing node receives, from the wireless device, the request for registration of the location related to the wireless device. The request comprises one of at least two subscriber identities referred to as “a primary subscriber identity”. The wireless device has been authenticated in the core network by use of the primary subscriber identity. The managing node further manages a set of indications of availability for said at least two subscriber identities. The availability indicates, to the managing node, whether or not to forward the request to the registration node.

In some embodiments, when an indication of availability for the primary subscriber identity is set to unavailable, the set of indications comprising the indication, the managing node refrains from forwarding the request to the registration node. Further, the managing node transmits a response to the wireless device. The response indicates that the wireless device is denied to be registered with the registration node due to undefined subscriber identity.

In some further embodiments, when an indication of availability for the primary subscriber identity is set to unavailable, the set of indications comprising the indication, the managing node replaces the primary subscriber identity of the request with a dummy subscriber identity. Moreover, in these embodiments, the managing node forwards the request to the registration node.

According to further aspects, the object is achieved by a subscriber identity component, a managing node, computer programs and computer program carriers corresponding to the aspects above.

The subscriber identity component cooperates with the managing node in order to detect and keep track of any accidental on going use, by a further subscriber identity component, of the primary subscriber identity. In the following, the subscriber identity component is distinguished from the further subscriber identity component. Likewise, the wireless device is distinguished from a further wireless device, which comprises the further subscriber identity component.

For example, assume that the further subscriber identity component provides the primary subscriber identity to be used by the further wireless device. Hence, when the subscriber identity component provides the primary subscriber identity to the wireless device, there will be a collision. This may thus happen when the further subscriber identity component has provided the primary subscriber identity prior to when the subscriber identity component provides the primary subscriber identity.

Authentication with the primary subscriber identity will nevertheless be valid for both the wireless device and the further wireless device. However, when the further wireless device registers with the registration node, the request for registration, aka location update, passes via the managing node, which sets the indication of availability for the primary subscriber identity to unavailable. Therefore, when the request for registration, originating from the wireless device, reaches the managing node, the managing node may initiate a rejection of the request for registration.

The rejection may be implemented by that the managing node refrains from forwarding the request to the registration node. Then, the managing node transmits the response to the wireless device.

Alternatively, the rejection may be implemented by that the managing node replaces the primary subscriber identity of the request with the dummy subscriber identity. The managing node then forwards the request to the registration node, which will send the response to the wireless device.

The initiation of the rejection will cause the information related to registration to indicate that the wireless device is denied to register the location in the network due to undefined subscriber, e.g. by that the managing node sends the response or by manipulating the request for registration as above to cause the registration node to send the response indicating that the wireless device is denied to be registered with the registration node due to undefined subscriber identity. The undefined subscriber identity may be unknown subscriber identity, illegal subscriber identity, system failure, data missing, unexpected data value, feature unsupported, unable to comply or the like. The response thus uses a known error code to indicate the undefined subscriber identity.

In this manner, only one wireless device, which obtained the primary subscriber identity first, will be able to successfully register with the registration node perform, such as perform location update or the like, e.g. during a time period or until a command indicating that the primary subscriber identity is available again is received by the managing node.

The subscriber identity component may, subsequent to valid authentication, monitor information related to registration. In this manner, the subscriber identity component may detect a pattern caused by the managing node. The pattern may be that information related to ciphering is validly updated and subsequently thereto the information related to registration indicates that registration was denied. Hence, the subscriber identity component may perform the set of actions again in order to provide a further primary subscriber identity to the wireless device. It is expected that the further primary subscriber identity is available, but it cannot be guaranteed. Therefore, it may in some cases be that the set of action may need to be performed repeatedly until an available primary subscriber identity is provided to the wireless device.

Irrespectively of the number of times the set of actions may be performed, the subscriber identity and/or the wireless device need not wait for the primary subscriber identity to become available. Thus, waiting time is reduced.

### BRIEF DESCRIPTION OF THE DRAWINGS

The various aspects of embodiments disclosed herein, including particular features and advantages thereof, will be readily understood from the following detailed description and the accompanying drawings, in which:

FIG. 1 is a schematic overview of an exemplifying network in which embodiments herein may be implemented,

FIG. 2 is a combined signaling and flowchart illustrating the methods herein,

FIG. 3 is a flowchart illustrating the method performed by the subscriber identity component according to embodiments herein,

FIG. 4 is a flowchart illustrating the method performed by the managing node according to embodiments herein,

FIG. 5 is a block diagram illustrating embodiments of the subscriber identity component, and

FIG. 6 is a block diagram illustrating embodiments of the managing node.

### DETAILED DESCRIPTION

Throughout the following description, similar reference numerals have been used to denote similar features, such as nodes, actions, modules, circuits, parts, items, elements, units or the like, when applicable. In the Figures, features that appear in some embodiments are indicated by dashed lines.

In order to better appreciate the embodiments herein, some further observations and explanations are provided here.

In pending and non-publicly available patent application SE1751187-4, a solution relating to simplification of stock management for subscriber identity components, such as SIM-cards, UICCs and the like, is presented. With this solution, it can happen that two devices accidentally calculate the same IMSI and then attempt to access the network simultaneously, or almost simultaneously. This causes the last device to receive messages even though these messages are intended for the device that accessed the network first. That is to say, a collision occurs.

In relation to this application, a problem may be how to handle collisions.

Throughout the following description, similar reference numerals have been used to denote similar features, such as nodes, actions, modules, circuits, parts, items, elements, units or the like, when applicable. In the Figures, features that appear in some embodiments are indicated by dashed lines.

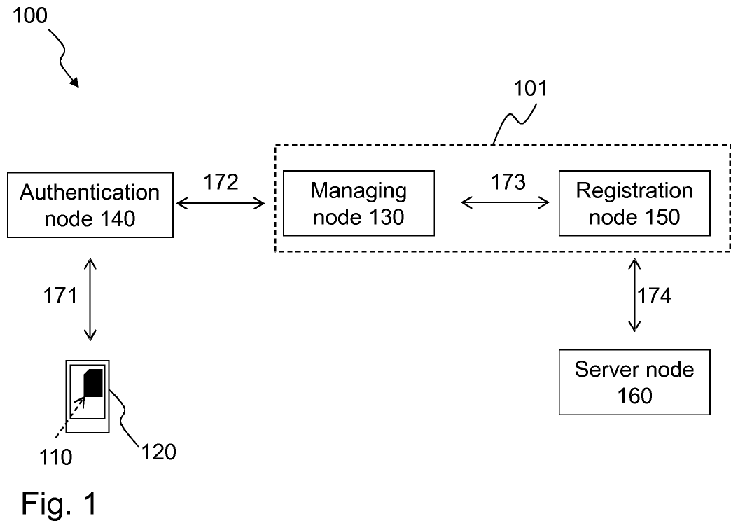

FIG. 1 depicts an exemplifying telecommunication network 100 in which embodiments herein may be implemented. In this example, the network 100 is a Global System for Mobile communication (GSM) network.

In other examples, the network 100 may be any cellular or wireless communication system, such as a Long Term Evolution (LTE), Universal Mobile Telecommunication System (UMTS) and Worldwide Interoperability for Microwave Access (WiMAX) or the like.

The telecommunication network 100 may comprise a core network 101, which may handle all kinds of typical core network tasks, such as mobility, subscription, policies, charging etc.

The network 100 may be said to comprise a wireless device 120. This means that the wireless device 120 is present in the network 100, i.e. within coverage of the network 100.

A subscriber identity component 110 is illustrated as being comprised in the wireless device 120. This means that the subscriber identity component 110 may be inserted into the wireless device 120 in a removable manner. Alternatively, the subscriber identity component 110 may be integrated with the wireless device 120 in a non-easily removable manner, e.g. soldered or as part of an integrated circuit of the wireless device 120. Further examples of the subscriber identity component 110 include, but are not limited to, a Subscriber Identity Module (SIM), eUICC, integrated UICC (iUICC), ICC, smart card, soft-SIM, embedded SIM, SIM/soft-SIM in combination with application software in the wireless device or the like. A soft-SIM may refer to that no particular SIM hardware exists and all SIM functionality is carried out by a software layer, such as a program or the like.

The subscriber identity component 110 and the wireless device 120 may exchange information with each other using information that is readable and/or writeable by both the subscriber identity component 110 and the wireless device 120. Such information may include information relating to ciphering, information related to registration and the like, whose use, content and context will be explained to the extent necessary for implementing the embodiments herein.

The information relating to ciphering may comprise Elementary File Ciphering Key (EF K_{C}), KC GRPS, Keys, Keys Packet Switched (PS), Evolved Packet System Non-Access Stratum Security Context (EPSNSC) and the like.

The information related to registration may comprise Elementary File Location Information (EF LOCI), LOCIGPRS, PSLOCI, EPSLOCI and the like.

The network 100 further comprises a managing node 130 for managing requests destined to a registration node 150, such as a Home Subscriber System (HSS), Home Location Register (HLR), a Unified Data Management (UDM), a 5^{th} Generation equivalent or the like. The network node 130 may comprise a Home Subscriber System, Home Location Register or the like. The requests will be described in more detail below. The core network 101 of the telecommunication network 100 may comprise the managing node 130 and the registration node 150.

Moreover, an authentication node 140 for managing authentication between the subscriber identity component 110 and the registration node 150 is illustrated in FIG. 1. The authentication node 140 may comprise one or more of Mobility Management Entity (MME), Visiting Location Register (VLR), Serving Gateway Support Node (SGSN), Access and Mobility Management Function (AMF), a 5^{th} Generation equivalent or the like. The core network 101 may also comprise the authentication node 140 (although not shown as such in the Figure).

Once the wireless device 120 is allowed into the network 100, the subscriber identity component 110 may communicate with e.g. a server node 160, such as a Subscription Manager (SM), a Subscription Manager Data Preparation (SM-DP), a Subscription Manager Secure Routing (SM-SR), a Connectivity Management Gateway (CMG), a 5^{th} Generation equivalent or the like. The CMG may handle provision of traffic subscriber identities based on an identity, such as a device identity, a component identity or the like.

The term “identity” may herein refer to a component identity relating to identification of the subscriber identity component 110 comprised in the wireless device 120 and/or a device identity relating identification of the wireless device 120.

The term “component identity” may refer to ICC identification (ID), eUICC ID (EID), or any other identification indicating the subscriber identity component 110.

The term “device identity” may refer to an International Mobile Equipment Identity (IMEI) or the like.

The authentication node 140 may communicate 171, e.g. via the wireless device 120 with the subscriber identity component 110, e.g. in order to exchange information as described herein. Furthermore, the authentication node 140 may communicate 172 with the managing node 130, e.g. again to exchange information as described herein. Additionally, the managing node 130 may communicate 173 with the registration node 150, e.g. to exchange information as described herein as well. Moreover, the registration node 150 may communicate 174 with the server node 160, e.g. to exchange information as described herein.

In the context of the present disclosure, the following terms may be used.

The term “subscriber identity” may refer to an International Mobile Subscriber Identity (IMSI) or the like.

The term “traffic subscriber identity” may refer to that such subscriber identity is permanent or temporary. Such traffic subscriber identity is typically unique, but may in some cases be non-unique.

The term “region” may refer to an operator's network coverage area, a country, a group of countries, business or customer segment in relation to an operator, or the like.

Moreover, the term “wireless device” may refer to a user equipment, a machine-to-machine (M2M) device, a mobile phone, a cellular phone, a Personal Digital Assistant (PDA) equipped with radio communication capabilities, a smartphone, a laptop or personal computer (PC) equipped with an internal or external mobile broadband modem, a tablet PC with radio communication capabilities, a portable electronic radio communication device, a sensor device equipped with radio communication capabilities or the like. The sensor device may detect any kind of metric, such as wind, temperature, air pressure, humidity, light, electricity, sound, images etc. Accordingly, the wireless device may refer to any so called IoT-device.

Furthermore, as used herein, the term “connectivity”, “network access”, “access granted”, “gain access” and the like may refer to that the wireless device is allowed into the network 100 and is able to transmit and/or receive messages using the network 100.

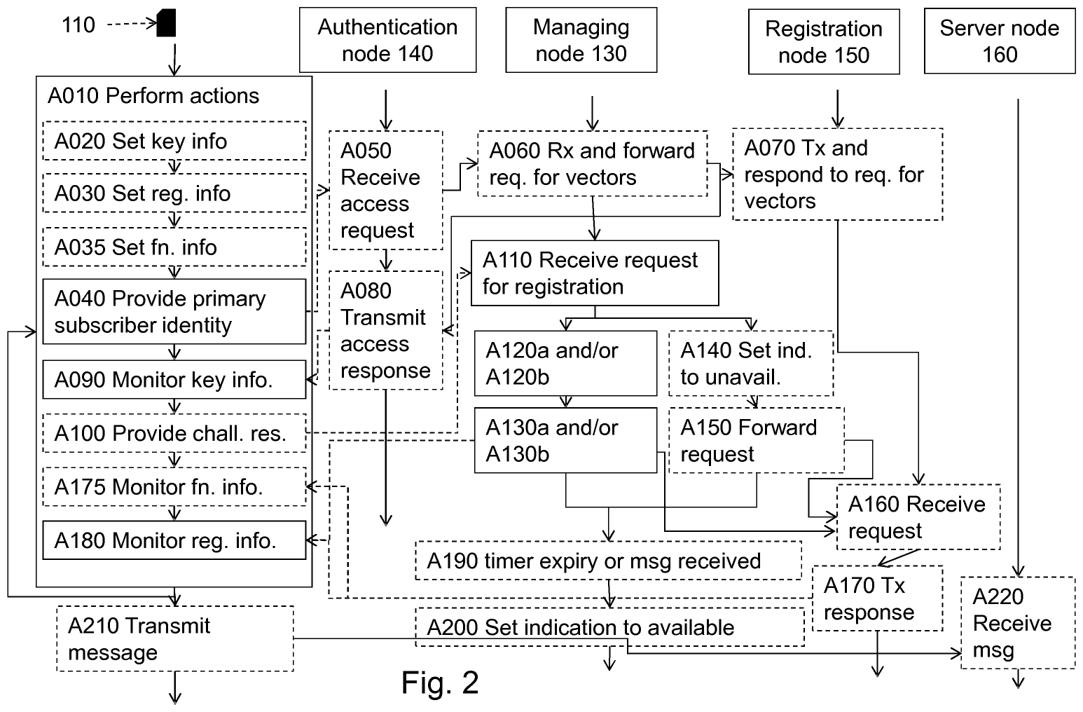

FIG. 2 illustrates an exemplifying method according to embodiments herein when implemented in the network 100 of FIG. 1.

The subscriber identity component 110 performs a method for providing a wireless device 120 with connectivity to a network 100. The managing node 130 performs a method for managing a request for registration with a registration node 150 for registration of a location related to a wireless device 120. As mentioned, the core network 101 of the telecommunication network 100 comprises the managing node 130 and the registration node 150.

One or more of the following actions may be performed in any suitable order.

Initially, the subscriber identity component 110 and/or the wireless device 120 may not previously have been provided with connectivity towards the network 100. Alternatively, the subscriber identity component 110 may have been instructed to cancel, such as reset, delete or the like, its current subscriber identity which may provide connectivity in some network (not shown).

Thus, when the wireless device 120 powers up, the wireless device 120 will also ensure that the subscriber identity component 110 is powered up.

### Action A010

E.g. upon power up or subsequent to action A180 below, the subscriber identity component 110 performs a set of actions, comprising at least actions A040, A090 and A180. In some embodiments, the set of actions also comprises action A175 below.

### Action A020

The subscriber identity component 110 may set the information related to ciphering (key info.) to a first predefined value. Since the subscriber identity component 110 may be aware of the first predefined value, the subscriber identity component 110 is able to monitor, as in action A090 below, the information related to ciphering for changes.

### Action A030

The subscriber identity component 110 may set the information related to registration (reg. info) to a second predefined value. Since the subscriber identity component 110 may be aware of the second predefined value, the subscriber identity component 110 is able to monitor, as in action A180 below, the information related to registration for changes.

The first predefined value may be equal to the second predefined value or the first predefined value may be different from the second predefined value.

As an example, the first predefined value and/or the second predefined value may be equal to 0xFF . . . FF expressed with hexadecimal notation. Any value, which cannot be confused as being an actual ciphering key, in case of the information related to ciphering, and/or actual network, e.g. PLMN, in case of the information related to registration, may be assigned to the first predefined value and/or the second predefined value if deemed suitable.

Action A020 and/or action A030 may be included in the set of actions. Sometimes, action A020 and/or action A030 are performed before action A010.

Typically, action A020 and/or action A030 may be performed when the information related to registration indicates that the wireless device 120 is denied to register the location in the network 100 as in action A180.

As a further example, action A020 and/or action A030 may be performed before action A040, or possibly during or even shortly after while still ensuring that any update to the information related to ciphering cannot happen before action A020 is performed. Similarly, action A030 may be performed at any time as long as it can be ensured that any update to the information related to registration cannot happen before action A030 is performed.

### Action A035

The subscriber identity component 110 may set information related for forbidden network (nf. info.) to a third predefined value. Since the subscriber identity component 110 may be aware of the third predefined value, the subscriber identity component 110 is able to monitor, as in action A175 below, the information related for forbidden network for changes.

As an example, the third predefined value may be equal to 0xFF . . . FF expressed with hexadecimal notation. Any value, which cannot be confused as being an actual forbidden network, e.g. PLMN, may be assigned to the third predefined value if deemed suitable.

### Action A040

In order to allow the wireless device 120 to fetch a subscriber identity from the subscriber identity component 110, the subscriber identity component 110 provides a primary subscriber identity out of at least two obtainable subscriber identities. Subsequently, by use of the primary subscriber identity, the wireless device 120 seeks connectivity in the network 100.

Said at least two obtainable subscriber identities may preferably be associated with active subscriptions that are registered in the registration node 150.

Said at least two obtainable subscriber identities may be stored in a list of subscriber identities from which the subscriber identity component 110 may select the primary subscriber identity. The list may be stored in a memory of the subscriber identity component 110. The selection of the primary subscriber identity may be random, be based on location of the wireless device 120, etc. It is also conceivable that that at least two obtainable subscriber identities are included in at least two applets, or profiles, which are stored in the subscriber identity component 110.

Moreover, said at least two obtainable subscriber identities may be determined, such as calculated, by the subscriber identity component 110, based on information about a set of pools of subscriber identities. Expressed differently, the providing according to action A040 comprises determining the primary subscriber identity based on information about a set of pools of subscriber identities. The information about the set of pools may be stored in the subscriber identity component 110, such as in a memory thereof.

In order to provide some background information relating to these embodiments, it is noted that subscriptions for any device must be activated in Mobile Network Operator (MNO)/Home Subscriber System (HSS)/Home Location Register (HLR) in order for the device to gain access to a network. In scenarios, such as IoT scenarios, where massive amounts of devices may be rolled out, the activation of subscriptions consume IMSIs, Mobile Station International Subscriber Directory Numbers (MSISDNs) and the like. This is problematic since the number of IMSIs and/or MSISDNs are/is not unlimited and there may be costs related to each activated IMSI and/or MSISDN. The cost may be related to license fees or similar.

In order to reduce cost and consumption of IMSIs and/or MSISDNs, estimations of a maximum number of subscribers, e.g. in terms of devices that may need connectivity, in each region are made. While it is desired that the estimations are conservative, to reduce consumption and cost, it shall also be ensured that one never runs out of active subscriptions, or active IMSIs. Running out of subscriptions would of course be detrimental to sales of subscriptions.

The traffic subscriber identity may typically be different, i.e. have different value, from so called pool subscriber identities as explained below. Notably, the traffic subscriber identities need also be active in the same sense as the pool subscriber identities in order to be able to provide connectivity when used.

The term “pool subscriber identity” may refer to that the subscriber identity is associated with a valid and active subscription according to a database, such as an HLR database, HSS database or the like. It shall be noted that the terms “traffic” and “pool” have been used merely to distinguish between these subscriber identities. A difference between traffic subscriber identities and pool subscriber identities is though that a pool subscriber identity is determined, or generated, when a need for connectivity arises, while a traffic subscriber identity is assigned to a certain subscriber identity component regardless whether or not the certain subscriber identity is involved in an attempt for obtaining connectivity or not.

The subscriber identity component 110 may, prior to first start-up, be provided with information defining a set of pools. Based on a pool taken from among the set of pools one or more pool subscriber identities may be derived. As an example, the pool may be defined by a so called Public Land Mobile Network (PLMN) identity, which is a combination of a Mobile Country Code (MCC) and Mobile Network Code (MNC) and two values indicative of a range in which subscriber identities may be determined as in action A020 below.

Each pool may be associated with a respective region. The respective region may be a coverage area of a network with or without roaming. Hence, the respective region may include one or more countries, geographical areas or the like. The respective region may be associated with a mobile network operator, which in turn also may be identified by a PLMN. At least one respective region is at least partially non-overlapping with at least one further respective region.

The subscriber identity component 110 may thus be provisioned with information defining a set of pools relating to pool subscriber identities. This may mean that the subscriber identity component 110 has not been provided with any particular subscriber identity, but instead the subscriber identity component 110 has been provided with the information defining the set of pools from which the subscriber identity component 110 is able to derive, e.g. determine, calculate etc., the primary subscriber identity, e.g. to be used upon when seeking connectivity in, e.g. attempting to access, the network 100. Expressed differently, the subscriber identity component 110 may have been provisioned with no subscriber identity, i.e. without any subscriber identity. In particular, the subscriber identity component 110 may be provided without any subscriber identity prior to first start-up, such as a first commissioning.

As an example, the pool subscriber identity may be calculated as follows. The pool may be identified by a PLMN identity, or PLMN Code, and a start-offset and a length. The length may of course instead be defined by a stop-offset considered in relation to the start-offset. Let's assume the PLMN to be 24007. The start-offset may be 9990000 and the length may be 500. Then the calculation may randomly, or quasi randomly, generate any subscriber identity in the range from 240079990000000 to 240079990000499. Should it be desired the range may be defined as from 240079990000001 to 240079990000500 or the like. Notably, the PLMN id may include 5 or 6 digits as is known in the art. In this manner, a risk for simultaneous attempts to obtain service from two different wireless devices whose respective subscriber identity components have accidentally calculated the same pool subscriber identity is predictable based on a length of the pool, estimated number of wireless device to be deployed per unit time and average time using the pool subscriber identity to utilize any service e.g. provided by the server node 140.

In some embodiments, each subscriber identity within a pool of subscriber identities may be associated with so called at least one Over The Air (OTA) key, preferably at least one unique OTA key. In this manner, it is ensured that when a message erroneously arrives at the wireless device 120 it cannot be decoded. That is, the message can only be decoded when the wireless device 120 is the intended recipient of the message, since it is only the intended recipient that has the correct OTA key. Here, “correct” OTA key mean that the message can be decode with the OTA key.

### Action A050

When the subscriber identity component 110 has provided the primary subscriber identity, the wireless device 120 may seek connectivity in the network 100. Amongst other things, the wireless device 120 may be said to transmit an access request to the authentication node 140.

Accordingly, the authentication node 140 may receive the access request, or a message caused by the access request. For example, the authentication node 140 may receive a so called UE INITIAL MESSAGE or the like.

The authentication node 140 handles routing of the access request, or a message derived from the access request. This may mean that the authentication node 140 may keep information about to which node an access request shall be forwarded based on which subscriber identity that is associated with the access request. The authentication node 140 may hence map one or more certain subscriber identities to a certain node. It is thus preferred that the authentication node 140 maps said at least two obtainable subscriber identities to the managing node 130. In this manner, it may be ensured that when a particular access request is associated with one of said at least two obtainable subscriber identities, the particular access request will be forwarded to the managing node 130.

In some examples, it may even be that the authentication node 140 may map certain commands and/or messages for said one or more certain subscriber identities to the certain node. Hence, in some examples this action may be omitted. Expressed differently, configuration of how the authentication node 140 shall route messages may be determined on command-level as well as on per subscriber identity, or group of subscriber identities.

### Action A060

Hence, since the primary subscriber identity is one of said at least two obtainable subscriber identities, the managing node 130 may receive, denoted Rx, the access request, or at least a message derived therefrom.

However, in some examples, the access request may be sent by the authentication node 140 directly to the registration node 130, i.e. completely transparent to the managing node 130.

As an example, the access request may be a so called request for vectors that may be used to obtain a challenge value, a desired response value associated with the challenge value, and other authentication related values as is known in the art. Further details are thus omitted for simplicity. The desired response value is often referred to as RES in related literature.

### Action A070

Irrespectively of whether the managing node 130 or the authentication node 140 has sent the request for vectors, aka the access request or the like, the registration node 150 may receive and respond to the request for vectors.

The registration node 150 may send an access response, which may—as mentioned above—include the challenge value and other authentication related values according to known procedures.

### Action A080

Following action A070, the authentication node 140 may receive and transmit the access response, which may or may not have passed via the managing node 130 with or without the managing node 130 being aware of the access response.

The access response may be transmitted to the wireless device 120. The information related to ciphering may be updated based on the access response.

Therefore, the subscriber identity component 110 during action A090 below may be made aware of a change of the information related to ciphering.

### Action A090

Accordingly, the subscriber identity component 110 monitors the information related to ciphering of communication to the network 100. In this manner, the subscriber identity component 110 may monitor progress of whether or not the subscriber identity component 110 has calculated requisite keys for the ciphering. This action may be performed prior to and during one or more of action A050 to action A080. It may be preferred that action A090 is performed after action A020, if action A020 is performed, and/or action A040.

Moreover, at this action the subscriber identity component 110 may start a timer, pick a time stamp, start a counter or the like, in order to track time, in terms of seconds, counts etc., lapsed since this action was performed. In this manner, the subscriber identity component 110 may interrupt e.g. action A180 in case the subscriber identity component 110 is not able to deduce what happened in the network on location update.

### Action A100

The subscriber identity component 110 may thus detect that the information relating to ciphering is different from the first predefined value. Alternatively, the subscriber identity component 110 may check if a valid key to be used for ciphering has been obtained.

The subscriber identity component 110 and/or the wireless device 120 thus provides a challenge response (chall. res.), commonly referred to as SRES in the art.

The challenge response may be transmitted (not shown), by the wireless device 120, to the authentication node 140. Then, the authentication node 140 may check (not shown) that the challenge response matches, e.g. is equal to, the desired response value of action A060 above. Thereafter, the authentication node 140 may send a request for registration to the managing node 130. The request for registration may be sent to the managing node 130, since—as previously mentioned—the authentication node 140 may route messages to different nodes based on the messages' association with subscriber identities. Hence, when the request for registration is associated with the primary subscriber identity, the authentication node 140 forwards, or routes, the request for registration to the managing node 130.

The request for registration may be update location, update General Packet Radio Service (GPRS) location according to 3GPP terminology or other request with same or similar purpose.

### Action A110

In view of the above, the managing node 130 eventually receives, from the wireless device 120, the request for registration of the location related to the wireless device 120.

The request may comprise, such as being associated with, one of at least two subscriber identities referred to as “a primary subscriber identity”. The wireless device 120 has been authenticated in the core network 101 by use of the primary subscriber identity.

The managing node 130 further manages a set of indications of availability for said at least two subscriber identities. The set of indications may comprise a respective indication for each one of said at least two subscriber identities. In the following, the respective indication for the primary subscriber identity may be referred to as “the indication of availability”.

The availability indicates, to the managing node 130, whether or not to forward the request to the registration node 150. As will be explained below, the indication may be set to available or unavailable depending on whether the managing node 130 deems the primary subscriber identity to be in-use or not in-use by any further subscriber identity component (not shown). Hence, as an example, the managing node 130 may check the indication to determine whether or not the primary subscriber identity shall be deemed to be in-use.

In the following at least one of some “return embodiments” and some “forwarding embodiments” may be performed.

When the indication of availability for the primary subscriber identity is set to unavailable, action A120a and action A130a according to the return embodiments may be performed. Additionally or preferably alternatively, action A120b and action A130b according to the forwarding embodiments may be performed when the indication of availability for the primary subscriber identity is set to unavailable.

### Action A120a

With the return embodiments, the managing node 130 refrains from forwarding the request to the registration node 150, since the indication of availability for the primary subscriber identity is set to unavailable.

### Action A130a

Furthermore, with the return embodiments, the managing node 130 transmits a response to the wireless device 120. The response indicates that the wireless device 120 is denied to be registered with the registration node 150 due to undefined subscriber identity. This response is thus sent by the managing node 130 when the indication indicates that the primary subscriber identity is unavailable, such as in-use.

The response uses an appropriate error code, such as unknown subscriber identity, illegal subscriber identity, system failure, data missing, unexpected data value, feature unsupported, unable to comply or the like.

Now turning to the forwarding embodiments, action A120b and action A130b may be performed.

### Action A120b

The managing node 130 replaces the primary subscriber identity of the request with a dummy subscriber identity, since the indication of availability for the primary subscriber identity is set to unavailable. In this manner, the managing node 130 may cause the registration node 150 to respond to the request with undefined subscriber in action A170 below.

### Action A130b

Now that the primary subscriber identity has been replaced, the managing node 130 forwards the request to the registration node 150. In this manner, the managing node 130 allows the registration node 150 to handle the registration response to be sent towards the wireless device 120.

Generally, the return and/or forwarding embodiments may be summarized as that, when the indication of availability for the primary subscriber identity is set to unavailable, the managing node 130 initiates a rejection of the request for registration at the registration node 150. The rejection may, according to the return and/or forwarding embodiments, cause the wireless device 120 to receive a response indicating that the wireless device 120 is denied to be registered with the registration node 150 due to undefined subscriber identity, e.g. as such response may be transmitted by the managing node 130 or as caused by the dummy subscriber identity or other replacement, such manipulation, in the request in case of the forwarding embodiments.

The return embodiments and the forwarding embodiments handle cases when the indication is set to unavailable. Action A140 and A150 below handle cases when the indication is set to available.

### Action A140

In order to keep track of that the primary subscriber identity may be occupied or in-use, the managing node 130 may set the indication for the primary subscriber identity to unavailable.

In this action, the managing node 130 may further start a timer, pick a time stamp or the like. In this manner, the managing node 130 may measure time lapsed since the indication was set to unavailable. The managing node 130 may be aware that the indication is expected to be unavailable for a time period, such as 10 s, 1 min, 1 hour or the like. Upon expiry to of the time period, action A190 below may be performed.

### Action A150

Since the indication was set to available before action A140 was performed, the managing node 130 may forward the request to the registration node 150. The managing node 130 is aware of that no other request for registration with that same primary subscriber identity is already in-use in that it has sent a request for registration to the registration node 150, i.e. without being released or timed out as will be explained with reference to action A190 and action A200 below.

### Action A160

The registration node 150 may receive the request for registration. The request may have been forwarded as in action A130b or as action A150.

### Action A170

Subsequent to action A160, the registration node 150 may transmit (Tx) a response towards the wireless device 120.

When action A130b has been performed, the primary subscriber identity may have been replaced with the dummy subscriber identity. The dummy subscriber identity does not exist in the registration node 150, i.e. the registration node 150 is not aware of the dummy subscriber identity. This causes the registration node 150 to respond that the dummy subscriber identity is unknown. Thus, the response indicates unknown subscriber identity. The request may have been manipulated in some other way, which more generally causes the response to indicate undefined subscriber identity.

When action A150 has been performed, the registration node 150 handles the request for registration provides an appropriate response based on the primary subscriber identity.

### Action A175

When the information related to ciphering indicates that the ciphering key has been obtained, e.g. as a result of action A090, the subscriber identity component 110 may then monitor information related to forbidden network.

Upon monitoring of the information related to forbidden network, the subscriber identity component 110 may detect that the information related to forbidden network indicates that the wireless device 120 is forbidden to register in the network 100.

Hence, in these embodiments, the set of actions may, e.g. only, be performed again provided that the information related to forbidden network refrains from indicating that the wireless device 120 is forbidden in the network 100, e.g. in combination with monitoring as in action A180.

For example, when the information related to forbidden network changes from the third predefined value, such as 0xFF . . . FF, to e.g. 0x42 F0 70 FF . . . FF, the subscriber identity component 110 may deduce that the registration was forbidden in the network 100.

In contrast thereto, when the information related to forbidden network indicates that the wireless device 120 is forbidden in the network 100, the subscriber identity component 110 may seek connectivity in another network (not shown) that is not forbidden. Alternatively, the subscriber identity component 110 may seek connectivity using a further subscriber identity taken from said at least two subscriber identities, where said further subscriber identity is different from the primary subscriber identity for which forbidden network was obtained.

In particular, it may be noted that the monitoring in action A090 of the information related to ciphering may be performed before the monitoring in action A175 of the information related to forbidden network.

### Action A180

When the information related to ciphering indicates that a ciphering key has been obtained, e.g. as a result of action A090, the subscriber identity component 110 then monitors information related to registration of a location of the wireless device 120 with the network 100.

Upon monitoring of the information related to registration, the subscriber identity component 110 may detect that the information related to registration indicates that the wireless device 120 is denied, such as not allowed, to register the location in the network 100.

Hence, when the information related to registration indicates that the wireless device 120 is denied to register the location in the network 100, the set of actions are performed again.

For example, when the information related to registration changes from the second predefined value, such as 0xFF . . . FF, to e.g. 0xFF . . . 03, the subscriber identity component 110 may deduce that the registration was not allowed due to that a dummy subscriber identity, e.g. a subscriber identity that is unknown to the network 100, was not recognised by the network 100, such as the registration node 150. In this manner, deviation(s) for the second predefined value, except for a status indication of e.g. “0x . . . 03” as above, may be detected and interpreted as that there is no collision.

As another example, the subscriber identity component 110 may monitor the information related to registration by checking if there exists at least one of a TMSI, a PLMN, a Location Area Identity (LAI) or the like. If so, the subscriber identity component may deduce that there is no collision.

It may here be noted that the term “monitor”, and forms thereof, may refer to that the subscriber identity component 110 periodically checks information, such as the information related to ciphering and/or registration, at least nearly periodically, or that the subscriber identity component 110 subscribes to an event relating to updating of the information, again such as the information related to ciphering and/or registration. In this context, the term “subscribe” is used as commonly known within the field of computer programming, i.e. such as to sign up for reception of messages when something, such as updating of the information, happens. Often in the context of publish/subscribe, but not necessarily.

In particular, it may be noted that the monitoring in action A090 of the information related to ciphering may be performed before the monitoring in action A180 of the information related to registration. This means that the subscriber identity component 110 may thus recognize a pattern according to authentication valid followed by, unexpectedly, registration not allowed. This sequence of a valid authentication followed by that registration is not allowed due to undefined subscriber, e.g. unknown subscriber as provoked by the dummy subscriber identity, can normally not happen. Therefore, the subscriber identity component 110 may deduce that there is a collision, i.e. the primary subscriber identity is in-use.

However, thanks to the managing node 130, the response to the request for registration may, depending on the indication of availability, be caused to indicate that the registration is not allowed due to undefined subscriber identity, e.g. by that the managing node 130 sends the response as in action A130a or by that the registration node 150 sends the response as in action A170 where the request has been manipulated by the managing node 130 in action A120b.

It may be preferred that action A175 is performed before action A180, since it action A175 indicates that forbidden network action A180 may not need to be performed at all. However, it is possible to perform action A180 before action A175 and then—before performing the set of actions again—execute action A175 and then, only if the information related to forbidden network refrains from indicating that the wireless device 120 is forbidden in the network 100, perform A010 the set of actions again.

In this action, the subscriber identity component 110 may monitor the information related to registration while expecting the information related to registration to indicate one of the following cases:
location update ok,
location update reject roaming area not allowed,
location update reject roaming area not allowed due to undefined subscriber identity, or the like.

In case of “location update ok”, there is no collision and the subscriber identity component 110 may proceed with action A210.

In case of “location update reject roaming area not allowed”, the subscriber identity component 110 may check that the information related to registration is different from the second predefined value, in addition to a status field of the information related to registration that already is found to indicate “location update reject roaming area not allowed”. When remaining fields, or at least parts of the remaining fields, are different from the second predefined value, the subscriber identity component 110 may deduce that the request for registration was denied due to roaming area not allowed. In this case, the subscriber identity component 110 may proceed by seeking connectivity in another network (not shown). Alternatively, the subscriber identity component 110 may seek connectivity using a further subscriber identity taken from said at least two subscriber identities, where said further subscriber identity is different from the primary subscriber identity for which forbidden network was obtained. “Roaming area” may sometimes be referred to as “location area”.

In case of “location update reject roaming area not allowed due to undefined subscriber identity”, the subscriber identity component 110 may check that the information related to registration is equal to the second predefined value, except for the status field of the information related to registration that already is found to indicate “location update reject roaming area not allowed”. When remaining fields, or at least parts of the remaining fields, are equal to the second predefined value, the subscriber identity component 110 may deduce that the request for registration was rejected as initiated by the managing node 130. As already mentioned, the set of actions may be performed again in this case.

In some cases, when action A175 may advantageously be performed, the subscriber identity component 110 may further expect, or distinguish, the following case: location update reject location area not allowed due to forbidden PLMN.

Thanks to that the subscriber identity component 110, in action A175 monitors the information related to forbidden network, the subscriber identity 110 is further able to distinguish when the information related to registration indicates location update reject location area not allowed due to forbidden PLMN. Since it may be that action A175 is performed before action A180, the subscriber identity component 110 may deduce that despite that the information related to registration changes as in case of “location update reject roaming area not allowed due to undefined subscriber identity”, it is in fact not a collision, since the information related to forbidden network indicates that the wireless device 120 is forbidden to register in the network 100. Therefore, the set of actions may not be performed again.

Now, recalling that e.g. a timer may be started in action A090, the subscriber identity component 110 may, in case the timer expires and none of the aforementioned cases has been identified, proceed by—as mentioned above - seeking connectivity in another network (not shown) that is not forbidden. Alternatively, the subscriber identity component 110 may—also as mentioned—perform A010 the set of actions again while seeking connectivity using a further subscriber identity taken from said at least two subscriber identities, where said further subscriber identity is different from the primary subscriber identity for which forbidden network was obtained.

### Action A190

When the time period from the setting A140 of the indication to unavailable lapses, the managing node 130 may perform action A200.

Alternatively, the managing node 130 may receive a command instructing the managing node 130 to set the primary subscriber identity to available. The command may be received from the server node 160.

### Action A200

In view action A190, when a time period from the setting A140 of the indication to unavailable lapses and/or when receiving, from the server node 160, the command instructing the managing node 130 to set the primary subscriber identity to available, the managing node 130 may set the indication to available.

In this manner, the primary subscriber identity may be released, i.e. its corresponding indication is set to available again, upon time out with respect to lapse of the time period since the indication of availability for the primary subscriber identity was set to unavailable.

Alternatively or additionally, the primary subscriber identity may be released as instructed by the server node 160 by means of the command.

### Action A210

When the information related registration indicates that the wireless device 120 is allowed to register the location in the network 100, the subscriber identity component 110 may transmit a message to the server node 160.

The message may instruct the server node 160 to provide a traffic subscriber identity to be used instead of said at least two obtainable subscriber identities. Alternatively or additionally, the message may comprise any payload data that the server node 160 is capable of handling. The payload data may comprise reports, statistics, measurement values, image information or the like.

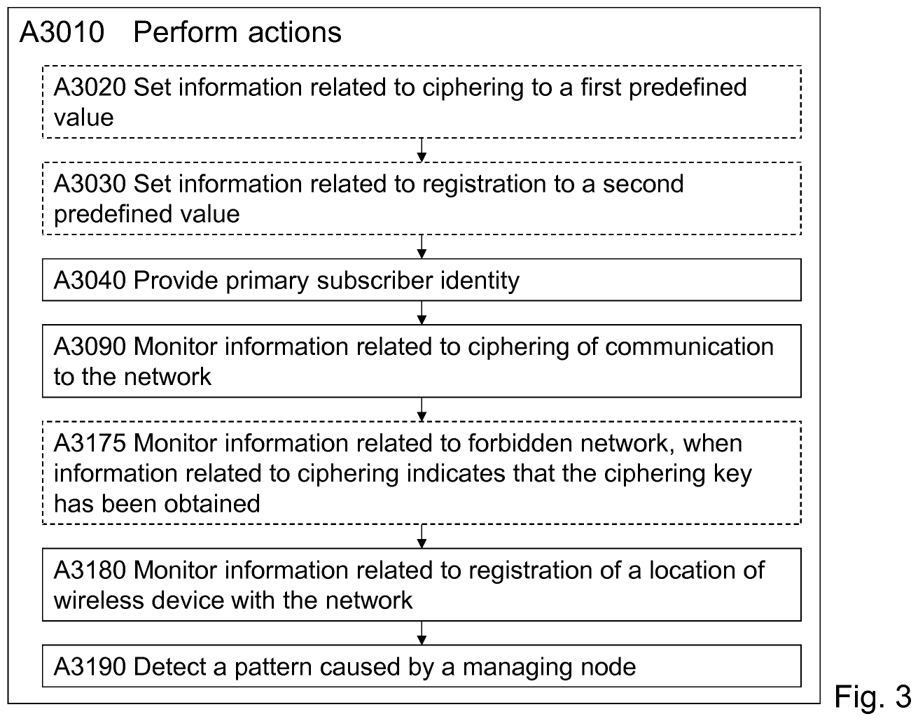

FIG. 3 illustrates an exemplifying method according to embodiments herein when implemented in the subscriber identity component 110 of FIG. 1.

The subscriber identity component 110 performs the method for providing a wireless device 120 with connectivity to the network 100.

Initially, the subscriber identity component 110 and/or the wireless device 120 may not previously have been provided with connectivity towards the network 100. Alternatively, the subscriber identity component 110 may have been instructed to cancel, such as reset, delete or the like, its current subscriber identity which may provide connectivity in some network (not shown).

Thus, when the wireless device 120 powers up, the wireless device 120 will also ensure that the subscriber identity component 110 is powered up.

One or more of the following actions may be performed in any suitable order.

### Action A3010

E.g. upon power up or subsequent to action A180 below, the subscriber identity component 110 performs a set of actions, comprising at least actions A3040, A3090 and A3080. In some embodiments, the set of actions also comprises action A3175 below. This action corresponds to Action A010 described in relation to FIG. 2.

### Action A3040

In order to allow the wireless device 120 to fetch a subscriber identity from the subscriber identity component 110, the subscriber identity component 110 provides a primary subscriber identity out of at least two obtainable subscriber identities. Subsequently, by use of the primary subscriber identity, the wireless device 120 seeks connectivity in the network 100. This action corresponds to Action A040 described in relation to FIG. 2.

### Action A3090

Accordingly, the subscriber identity component 110 monitors the information related to ciphering of communication to the network 100. This action corresponds to Action A090 described in relation to FIG. 2.

### Action A3175

When the information related to ciphering indicates that the ciphering key has been obtained, e.g. as a result of action A3090, the subscriber identity component 110 may then monitor information related to forbidden network. This action corresponds to Action A175 described in relation to FIG. 2.

### Action A3180

When the information related to ciphering indicates that a ciphering key has been obtained, e.g. as a result of action A3090, the subscriber identity component 110 then monitors information related to registration of a location of the wireless device 120 with the network 100. This action corresponds to Action A180 described in relation to FIG. 2.

### Action A3190

When the information related to registration indicates that the wireless device 120 is denied to register the location in the network 100, e.g. as a result of action A3180, the subscriber identity component 110 detects a pattern caused by the managing node 130, wherein the pattern is that the information related to ciphering is validly updated and subsequently thereto the information related to registration indicates that registration was denied due to undefined subscriber identity.

The subscriber identity component 110 then performs the set of actions again in order to provide a further primary subscriber identity to the wireless device 120. In other words, the subscriber identity component 110 performs action A3010 again.

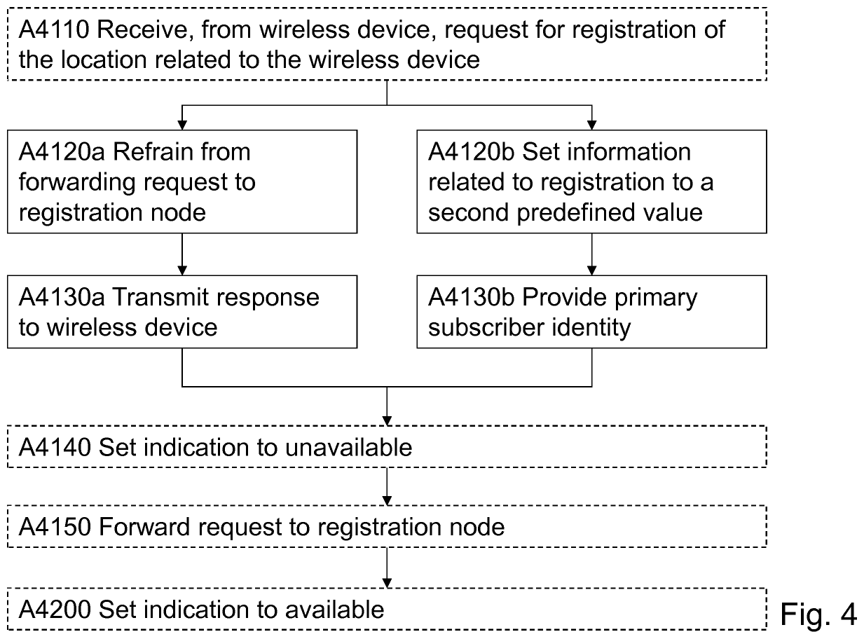

FIG. 4 illustrates an exemplifying method according to embodiments herein when implemented in the network 100 of FIG. 1.

The managing node 130 performs a method for managing a request for registration with a registration node 150 for registration of a location related to a wireless device 120.

One or more of the following actions may be performed in any suitable order.

### Action A4110

The managing node 130 receives, from the wireless device 120, the request for registration of the location related to the wireless device 120. The request comprises, such as being associated with, one of at least two subscriber identities referred to as “a primary subscriber identity”. The wireless device 120 has been authenticated in the core network 101 by use of the primary subscriber identity. The managing node 130 further manages a set of indications of availability for said at least two subscriber identities. The set of indications may comprise a respective indication for each one of said at least two subscriber identities. The indications are set to available or unavailable depending on whether the managing node 130 deems the primary subscriber identity to be in-use or not in-use, by any further subscriber identity component, for registration with the registration node 150. This action is similar to Action A110 described in relation to FIG. 2.

In the following at least one of some “return embodiments” and some “forwarding embodiments” may be performed.

When the indication of availability for the primary subscriber identity is set to unavailable, action A4120a and action A4130a according to the return embodiments may be performed. Additionally or preferably alternatively, action A4120b and action A4130b according to the forwarding embodiments may be performed when the indication of availability for the primary subscriber identity is set to unavailable.

### Action A4120a

With the return embodiments, the managing node 130 refrains from forwarding the request to the registration node 150, since the indication of availability for the primary subscriber identity is set to unavailable. This action corresponds to Action A120a described in relation to FIG. 2.

### Action A4130a

Furthermore, with the return embodiments, the managing node 130 transmits a response to the wireless device 120. The response indicates that the wireless device 120 is denied to be registered with the registration node 150 due to undefined subscriber identity. This response is thus sent by the managing node 130 when the indication indicates that the primary subscriber identity is unavailable, such as in-use.

The response uses an appropriate error code, such as unknown subscriber identity, illegal subscriber identity, system failure, data missing, unexpected data value, feature unsupported, unable to comply or the like. This action corresponds to Action A130a described in relation to FIG. 2.

Now turning to the forwarding embodiments, action A4120b and action A4130b may be performed.

### Action A4120b

The managing node 130 replaces the primary subscriber identity of the request with a dummy subscriber identity, since the indication of availability for the primary subscriber identity is set to unavailable. This action corresponds to Action A120b described in relation to FIG. 2.

### Action A4130b

Now that the primary subscriber identity has been replaced, the managing node 130 forwards the request to the registration node 150. In this manner, the managing node 130 allows the registration node 150 to handle the registration response to be sent towards the wireless device 120. This action corresponds to Action A130b described in relation to FIG. 2.

### Action A4140

In order to keep track of that the primary subscriber identity may be occupied or in-use, the managing node 130 may set the indication for the primary subscriber identity to unavailable. This action corresponds to Action A140 described in relation to FIG. 2.

### Action A4200

When a time period from the setting A4140 of the indication to unavailable lapses and/or when receiving, from the server node 160, the command instructing the managing node 130 to set the primary subscriber identity to available, the managing node 130 may set the indication to available. This action corresponds to Action A200 described in relation to FIG. 2.

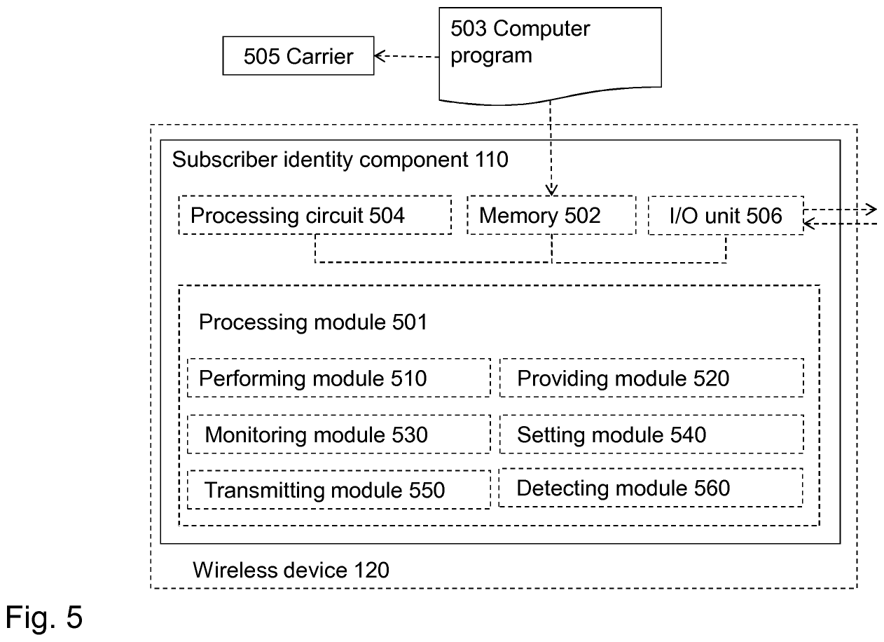

With reference to FIG. 5, a schematic block diagram of embodiments of the subscriber identity component 110 of FIG. 1 is shown.

The subscriber identity component 110 may comprise a processing module 501, such as a means for performing the methods described herein. The means may be embodied in the form of one or more hardware modules and/or one or more software modules. The term “module” may thus refer to a circuit, a software block or the like according to various embodiments as described below.

The subscriber identity component 110 may further comprise a memory 502. The memory may comprise, such as contain or store, instructions, e.g. in the form of a computer program 503, which may comprise computer readable code units.

According to some embodiments herein, the subscriber identity component 110 and/or the processing module 501 comprises a processing circuit 504 as an exemplifying hardware module, which may comprise one or more processors. Accordingly, the processing module 501 may be embodied in the form of, or ‘realized by’, the processing circuit 504. The instructions may be executable by the processing circuit 504, whereby the subscriber identity component 110 is operative to perform the methods of FIG. 2 and/or FIG. 3. As another example, the instructions, when executed by the subscriber identity component 110 and/or the processing circuit 504, may cause the subscriber identity component 110 to perform the method of FIG. 2 and/or FIG. 3.

In view of the above, in one example, there is provided a subscriber identity component 110 for providing a wireless device 120 with connectivity to a network 100. Again, the memory 502 contains the instructions executable by said processing circuit 504 whereby the subscriber identity component 110 is operative for:
performing a set of actions, comprising:
   providing a primary subscriber identity out of at least two obtainable subscriber identities, whereby the wireless device 120 seeks connectivity in the network 100 by use of the primary subscriber identity,
   monitoring information related to ciphering of communication to the network 100,
   when the information related to ciphering indicates that a ciphering key has been obtained, monitoring information related to registration of a location of the wireless device 120 with the network 100,
when the information related to registration indicates that the wireless device 120 is denied to register the location in the network 100, detecting a pattern caused by a managing node 130, wherein the pattern is that the information related to ciphering is validly updated and subsequently thereto the information related to registration indicates that registration was denied due to undefined subscriber identity, and
performing the set of actions again in order to provide a further primary subscriber identity to the wireless device 120.

FIG. 5 further illustrates a carrier 505, or program carrier, which comprises the computer program 503 as described directly above. The carrier 505 may be one of an electronic signal, an optical signal, a radio signal and a computer readable medium.

In some embodiments, the subscriber identity component 110 and/or the processing module 501 may comprise one or more of a performing module 510, a providing module 520, a monitoring module 530, a setting module 540, a transmitting module 550 and a detecting module 560 as exemplifying hardware modules. The term “module” may refer to a circuit when the term “module” refers to a hardware module. In other examples, one or more of the aforementioned exemplifying hardware modules may be implemented as one or more software modules.

Moreover, the subscriber identity component 110 and/or the processing module 501 comprises an Input/Output unit 506, which may be exemplified by a receiving module and/or the transmitting module when applicable.

Accordingly, the subscriber identity component 110 is configured for providing a wireless device 120 with connectivity to a network 100.

Therefore, according to the various embodiments described above, the subscriber identity component 110 and/or the processing module 501 and/or the performing module 510 is configured for performing a set of actions. The set of actions comprises that the subscriber identity component 110 and/or the processing module 501 and/or the providing module 520 is configured for providing a primary subscriber identity out of at least two obtainable subscriber identities, whereby the wireless device 120 seeks connectivity in the network 100 by use of the primary subscriber identity.

Moreover, the set of actions comprises that the subscriber identity component 110 and/or the processing module 501 and/or the monitoring module 530 is configured for monitoring information related to ciphering of communication to the network 100. The set of actions also comprises that the subscriber identity component 110 and/or the processing module 501 and/or the monitoring module 530, or a further monitoring module (not shown), is configured for monitoring information related to registration of a location of the wireless device 120 with the network 100, when the information related to ciphering indicates that a ciphering key has been obtained.

The subscriber identity component 110 and/or the detecting module 560 is configured for detecting a pattern caused by a managing node 130, wherein the pattern is that the information related to ciphering is validly updated and subsequently thereto the information related to registration indicates that registration was denied due to undefined subscriber identity.

The subscriber identity component 110 and/or the processing module 501 is configured for performing the set of actions again in order to provide a further primary subscriber identity to the wireless device 120.

The subscriber identity component 110 and/or the processing module 501 may further be configured for performing the set of actions again when the information related to registration indicates that the wireless device 120 is denied to register the location in the network 100.

The subscriber identity component 110 and/or the processing module 501 and/or the setting module 540 may be configured for, before performing A010 the set of actions again and/or when the information related to registration indicates that the wireless device 120 is denied to register the location in the network 100, setting the information related to ciphering to a first predefined value.

The subscriber identity component 110 and/or the processing module 501 and/or the setting module 540, or a further setting module (not shown), may be configured for setting the information related to registration to a second predefined value.

The subscriber identity component 110 may be configured for monitoring the information related to ciphering before monitoring the information related to registration.

The subscriber identity component 110 and/or the processing module 501 and/or the transmitting module 550 may be configured for transmitting a message to a server node 160, when the information related registration indicates that the wireless device 120 is allowed to register the location in the network 100.

FIG. 5 further illustrates a wireless device 120 comprising the subscriber identity component 110.

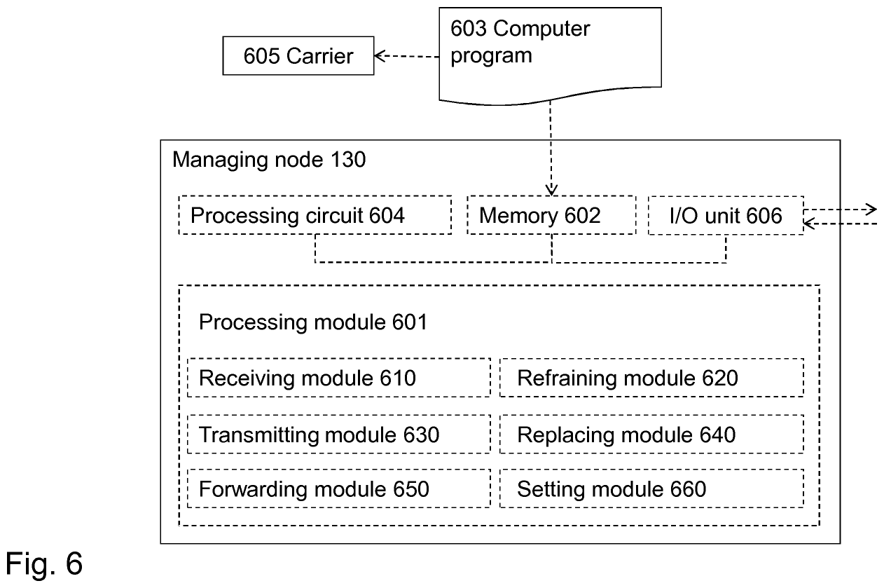

With reference to FIG. 6, a schematic block diagram of embodiments of the managing node 130 of FIG. 1 is shown.

The managing node 130 may comprise a processing module 601, such as a means for performing the methods described herein. The means may be embodied in the form of one or more hardware modules and/or one or more software modules. The term “module” may thus refer to a circuit, a software block or the like according to various embodiments as described below.

The managing node 130 may further comprise a memory 602. The memory may comprise, such as contain or store, instructions, e.g. in the form of a computer program 603, which may comprise computer readable code units.

According to some embodiments herein, the managing node 130 and/or the processing module 601 comprises a processing circuit 604 as an exemplifying hardware module. Accordingly, the processing module 601 may be embodied in the form of, or ‘realized by’, the processing circuit 604. The instructions may be executable by the processing circuit 604, whereby the managing node 130 is operative to perform the methods of FIG. 2 and/or FIG. 4. As another example, the instructions, when executed by the managing node 130 and/or the processing circuit 604, may cause the managing node 130 to perform the method according to FIG. 2 and/or FIG. 4.

In view of the above, in one example, there is provided a managing node 130 for managing a request for registration with a registration node for registration of a location related to a wireless device. As mentioned, a core network of a telecommunication network comprises the managing node and the registration node. Again, the memory 602 contains the instructions executable by said processing circuit 604 whereby the managing node 130 is operative for performing a method comprising:
receiving, from the wireless device, the request for registration of the location related to the wireless device, wherein the request comprises one of at least two subscriber identities referred to as “a primary subscriber identity”, wherein the wireless device has been authenticated in the core network by use of the primary subscriber identity, wherein the managing node further manages a set of indications of availability for said at least two subscriber identities, wherein the indications are set to available or unavailable depending on whether the managing node (130) deems the primary subscriber identity to be in-use or not in-use, by any further subscriber identity component, for registration with the registration node (150), and
wherein the method comprises, when an indication of availability for the primary subscriber identity is set to unavailable, the set of indications comprising the indication:

refraining from forwarding the request to the registration node, and
transmitting a response to the wireless device, wherein the response indicates that the wireless device is denied to be registered with the registration node due to undefined subscriber identity, or wherein the method comprises, when an indication of availability for the primary subscriber identity is set to unavailable, the set of indications comprising the indication:
replacing the primary subscriber identity of the request with a dummy subscriber identity, and
forwarding the request to the registration node.

The availability may e.g. indicate, to the managing node 130, whether or not to forward the request to the registration node.

FIG. 6 further illustrates a carrier 605, or program carrier, which comprises the computer program 603 as described directly above. The carrier 605 may be one of an electronic signal, an optical signal, a radio signal and a computer readable medium.

In further embodiments, the managing node 130 and/or the processing module 601 may comprise one or more of a receiving module 610, a refraining module 620, a transmitting module 630, a replacing module 640, a forwarding module 650, and a setting module 660 as exemplifying hardware modules. The term “module” may refer to a circuit when the term “module” refers to a hardware module. In other examples, one or more of the aforementioned exemplifying hardware modules may be implemented as one or more software modules.

Moreover, the managing node 130 and/or the processing module 601 comprises an Input/Output unit 606, which may be exemplified by the receiving module and/or the transmitting module when applicable.

Accordingly, the managing node 130 is configured for managing a request for registration with a registration node 150 for registration of a location related to a wireless device 120. As mentioned, a core network 101 of a telecommunication network 100 comprises the managing node 130 and the registration node 150.

Therefore, according to the various embodiments described above, the managing node 130 and/or the processing module 601 and/or the receiving module 610 is configured for receiving, from the wireless device 120, the request for registration of the location related to the wireless device 120. The request comprises one of at least two subscriber identities referred to as “a primary subscriber identity”. The wireless device 120 has been authenticated in the core network 101 by use of the primary subscriber identity. The managing node 130 further is configured for managing a set of indications of availability for said at least two subscriber identities. The availability indicates, to the managing node 130, whether or not to forward the request to the registration node 150. The managing node 130 is configured, when an indication of availability for the primary subscriber identity is set to unavailable, the set of indications comprising the indication, as follows:

The managing node 130 and/or the processing module 601 and/or the refraining module 620 is configured for refraining from forwarding the request to the registration node 150.

The managing node 130 and/or the processing module 601 and/or the transmitting module 630 is configured for transmitting a response to the wireless device 120. The response indicates that the wireless device 120 is denied to be registered with the registration node 150 due to undefined subscriber identity.

Alternatively or additionally, the managing node 130 is configured, when an indication of availability for the primary subscriber identity is set to unavailable, the set of indications comprising the indication, as follows:

The managing node 130 and/or the processing module 601 and/or the replacing module 640 is configured for replacing the primary subscriber identity of the request with a dummy subscriber identity.

The managing node 130 and/or the processing module 601 and/or the forwarding module 650 is configured for forwarding the request to the registration node 150.

The managing node 130 and/or the processing module 601 and/or the setting module 660 may be configured for setting the indication to unavailable, when the indication is set to available.

The managing node 130 and/or the processing module 601 and/or the forwarding module 650, or a further forwarding module (not shown), may be configured for forwarding the request to the registration node 150.

The managing node 130 and/or the processing module 601 and/or the setting module 610 may be configured for setting the indication to available, when a time period from the setting of the indication to unavailable lapses and/or when receiving, from a server node 160, a command instructing the managing node 130 to set the primary subscriber identity to available.

As used herein, the term “node”, or “network node”, may refer to one or more physical entities, such as devices, apparatuses, computers, servers or the like. This may mean that embodiments herein may be implemented in one physical entity. Alternatively, the embodiments herein may be implemented in a plurality of physical entities, such as an arrangement comprising said one or more physical entities, i.e. the embodiments may be implemented in a distributed manner, such as on cloud system, which may comprise a set of server machines.

As used herein, the term “module” may refer to one or more functional modules, each of which may be implemented as one or more hardware modules and/or one or more software modules and/or a combined software/hardware module in a node. In some examples, the module may represent a functional unit realized as software and/or hardware of the node.

As used herein, the term “software module” may refer to a software application, a Dynamic Link Library (DLL), a software component, a software object, an object according to Component Object Model (COM), a software function, a software engine, an executable binary software file or the like.

As used herein, the term “processing module” may include one or more hardware modules, one or more software modules or a combination thereof. Any such module, be it a hardware, software or a combined hardware-software module, may be a determining means, estimating means, capturing means, associating means, comparing means, identification means, selecting means, receiving means, sending means or the like as disclosed herein. As an example, the expression “means” may be a module corresponding to the modules listed above in conjunction with the Figures. The terms “processing module” or “processing circuit” may herein encompass a processing unit, comprising e.g. one or more processors, an Application Specific integrated Circuit (ASIC), a Field-Programmable Gate Array (FPGA) or the like. The processing circuit or the like may comprise one or more processor kernels.

As used herein, the term “memory” may refer to a hard disk, a magnetic storage medium, a portable computer diskette or disc, flash memory, random access memory (RAM) or the like. Furthermore, the term “memory” may refer to an internal register memory of a processor or the like.

As used herein, the term “computer program carrier”, “program carrier”, or “carrier”, may refer to one of an electronic signal, an optical signal, a radio signal, and a computer readable medium. In some examples, the computer program carrier may exclude transitory, propagating signals, such as the electronic, optical and/or radio signal. Thus, in these examples, the computer program carrier may be a non-transitory carrier, such as a non-transitory computer readable medium.

As used herein, the term “computer readable medium” may be a Universal Serial Bus (USB) memory, a Digital Versatile Disc (DVD), a Blu-ray disc, a software module that is received as a stream of data, a Flash memory, a hard drive, a memory card, such as a MemoryStick, a Multimedia Card (MMC), Secure Digital (SD) card, etc. One or more of the aforementioned examples of computer readable medium may be provided as one or more computer program products.

As used herein, the term “computer readable code units” may be text of a computer program, parts of or an entire binary file representing a computer program in a compiled format or anything there between.

As used herein, the expression “configured to/for” may mean that a processing circuit is configured to, such as adapted to or operative to, by means of software configuration and/or hardware configuration, perform one or more of the actions described herein.

As used herein, the term “action” may refer to an action, a step, an operation, a response, a reaction, an activity or the like. It shall be noted that an action herein may be split into two or more sub-actions as applicable. Moreover, also as applicable, it shall be noted that two or more of the actions described herein may be merged into a single action.

As used herein, the expression “transmit” and “send” are considered to be interchangeable. These expressions include transmission by broadcasting, uni-casting, group-casting and the like. In this context, a transmission by broadcasting may be received and decoded by any authorized device within range. In case of uni-casting, one specifically addressed device may receive and decode the transmission. In case of group-casting, a group of specifically addressed devices may receive and decode the transmission.

As used herein, the terms “number” and/or “value” may be any kind of digit, such as binary, real, imaginary or rational number or the like. Moreover, “number” and/or “value” may be one or more characters, such as a letter or a string of letters. “Number” and/or “value” may also be represented by a string of bits, i.e. zeros and/or ones.

As used herein, the terms “first”, “second”, “third” etc. may have been used merely to distinguish features, apparatuses, elements, units, or the like from one another unless otherwise evident from the context.

As used herein, the term “subsequent action” may refer to that one action is performed after a preceding action, while additional actions may or may not be performed before said one action, but after the preceding action.

As used herein, the term “set of” may refer to one or more of something. E.g. a set of devices may refer to one or more devices, a set of parameters may refer to one or more parameters or the like according to the embodiments herein.

As used herein, the expression “in some embodiments” has been used to indicate that the features of the embodiment described may be combined with any other embodiment disclosed herein.

Even though embodiments of the various aspects have been described, many different alterations, modifications and the like thereof will become apparent for those skilled in the art. The described embodiments are therefore not intended to limit the scope of the present disclosure.

1.-21. (canceled)

22. A method, performed by a subscriber identity component, for providing a wireless device with connectivity to a network, comprising:
performing a set of actions, comprising:
providing a primary subscriber identity out of at least two obtainable subscriber identities, whereby the wireless device seeks connectivity in the network by use of the primary subscriber identity, monitoring information related to ciphering of communication to the network,
when the information related to ciphering indicates that a ciphering key has been obtained, monitoring information related to registration of a location of the wireless device with the network, when the information related to registration indicates that the wireless device is denied to register the location in the network, detecting a pattern caused by a managing node , wherein the pattern is that the information related to ciphering is validly updated and subsequently thereto the information related to registration indicates that registration was denied due to undefined subscriber identity, and
performing the set of actions again in order to provide a further primary subscriber identity to the wireless device.

23. The method according to claim 22, wherein the method comprises:
when the information related to ciphering indicates that the ciphering key has been obtained, monitoring information related to forbidden network, wherein the set of actions are performed again provided that the information related to forbidden network refrains from indicating that the wireless device is forbidden in the network.

24. The method according to claim 22, wherein at least one of, before performing the set of actions or when the information related to registration indicates that the wireless device is denied to register the location in the network:
setting the information related to ciphering to a first predefined value, and
setting the information related to registration to a second predefined value.

25. (New j The method according to claim 23, wherein the monitoring of the information related to ciphering is performed before the monitoring of the information related to registration.

26. The method according to claim 22, further comprises, when the information related registration indicates that the wireless device is allowed to register the location in the network:
transmitting a message to a server node.

27. A method, performed by a managing node, for managing a request for registration with a registration node for registration of a location related to a wireless device, wherein a core network of a telecommunication network comprises the managing node and the registration node, comprising:
receiving, from the wireless device, the request for registration of the location related to the wireless device, wherein the request comprises one of at least two subscriber identities, wherein the wireless device has been authenticated in the core network by use of the at least two subscriber identities, wherein the managing node further manages a set of indications of availability for said at least two subscriber identities, wherein the indications are set to available or unavailable depending on whether the managing node deems the at least two subscriber identities to be in-use or not in-use, by any further subscriber identity component, for registration with the registration node, and
when an indication of availability for the at least two subscriber identities is set to unavailable, the set of indications comprising the indication:
refraining from forwarding the request to the registration node, and
transmitting a response to the wireless device, wherein the response indicates that the wireless device is denied to be registered with the registration node due to undefined subscriber identity;
when an indication of availability for the at least two subscriber identities is set to unavailable, the set of indications comprising the indication:
replacing the primary subscriber identity of the request with a dummy subscriber identity, and
forwarding the request to the registration node.

28. The method according to claim 27, wherein, when the indication is set to available, further comprising:
setting the indication to unavailable, and
forwarding the request to the registration node.

29. The method according to the claim 28, further comprising:
when at least one of a time period from the setting of the indication to unavailable lapses or when receiving, from a server node, a command instructing the managing node to set the primary subscriber identity to available:
setting the indication to available.

30. A subscriber identity component, for providing a wireless device with connectivity to a network, the subscriber identity component performing the method comprising:
perform a set of actions configured to:
provide a primary subscriber identity out of at least two obtainable subscriber identities, whereby the wireless device seeks connectivity in he network by use of the primary subscriber identity,
monitor information related to ciphering of communication to the network,
when the information related to ciphering indicates that a ciphering key has been obtained, monitor information related to registration of a location of the wireless device with the network,
when the information related to registration indicates that the wireless device is denied to register the location in the network, detect a pattern caused by a managing node, wherein the pattern is that the information related to ciphering is validly updated and subsequently thereto the information related to registration indicates that registration was denied due to undefined subscriber identity, and
perform the set of actions again in order to provide a further primary subscriber identity to the wireless device.

31. The subscriber identity component according to claim, wherein the subscriber identity component is configured to:
when the information related to ciphering indicates that the ciphering key has been obtained, monitor information related to forbidden network,
wherein the subscriber identity component is configured to perform the set of actions again if the information related to forbidden network refrains from indicating that the wireless device is forbidden in the network.

32. The subscriber identity component according to claim 31, wherein the subscriber identity component is configured to:
before at least one of performing the set of actions or when the information related to registration indicates that the wireless device is denied to register the location in the network, set the information related to ciphering to a first predefined value, and set the information related to registration to a second predefined value.

33. The subscriber identity component according to claim 32, wherein the subscriber identity component is further configured to perform the monitoring of the information related to ciphering before the monitoring of the information related to registration.

34. The subscriber identity component according to claim 33, wherein the subscriber identity component is further configured to:
transmit a message to a server node, when the information related to registration indicates that the wireless device is allowed to register the location in the network.
